(19) United States
(12) Patent Application Publication
(10) Pub. No.: US 2016/0153451 A1
(43) Pub. Date: Jun. 2, 2016

(54) Remote air supply

(71) Applicant: Marty Ingram, Grand Prairie, TX (US)

(72) Inventor: Marty Ingram, Grand Prairie, TX (US)

(21) Appl. No.: 14/556,181

(22) Filed: Nov. 30, 2014

(51) Int. Cl. F04C 15/00; F04C 2/30; B08B 5/02

(52) U.S. Cl. CPC F04C 15/008; B08B 5/02; F04C 2/30

(57) ABSTRACT

A cleaning system for providing a compressed fluid and to clean a coil of an air conditioner include a portable power supply; a motor connected to the portable power supply to rotate a shaft; a cam connected to the shaft to drive a reciprocating linear motion camshaft; and a piston connected to the camshaft to provide pressurized fluid.

### FIELD OF THE INVENTION

This invention relates generally to pressure systems and more particularly to a portable pressure system used principally for gently cleaning fine particulate matter from hard to reach AC evaporator coils.

### BACKGROUND

Dirt and other contaminates, such as grease, pollen, hair spray, etc., on air-conditioning coils present a serious maintenance problem in residential or commercial buildings. Dirty coils reduce airflow, decrease efficiency, reduce HVAC capacity, and are a major cause of compressor failure and sick building syndrome.

Indoor coils known as evaporator coils are located in the air handler portion of the system and are generally fitted with intake filters

The most common type of AC coil is the A-frame type whereby a pair of coils is arranged back-to-back forming an “A”. Such coils are placed in the air handling system so as to pass intake air across the coils, using a blower fan, and into the ventilation ducts. Contaminates in the air stream tend to settle on the face of one coil and on the under side of the adjacent coil. Using brushes, foams, water spray and the like to clean the exterior faces of coils while in place simply forces the contaminates further into the coils because of inaccessibility of the coils from either side.

### SUMMARY

A cleaning system for providing a compressed fluid and to clean a coil of an air conditioner include a portable power supply; a motor connected to the portable power supply to rotate a shaft; a cam connected to the shaft to drive a reciprocating linear motion camshaft; and a piston connected to the camshaft to provide pressurized fluid.

The portable power supply may be a cordless drill.

The shaft may be connected to a drill bit of a cordless drill.

The piston may be a rotary piston.

The piston may be a scroll piston.

The piston may be an air piston.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a diagram of the present invention;

FIG. 2 illustrates another diagram of the present invention,

### DETAILED DESCRIPTION

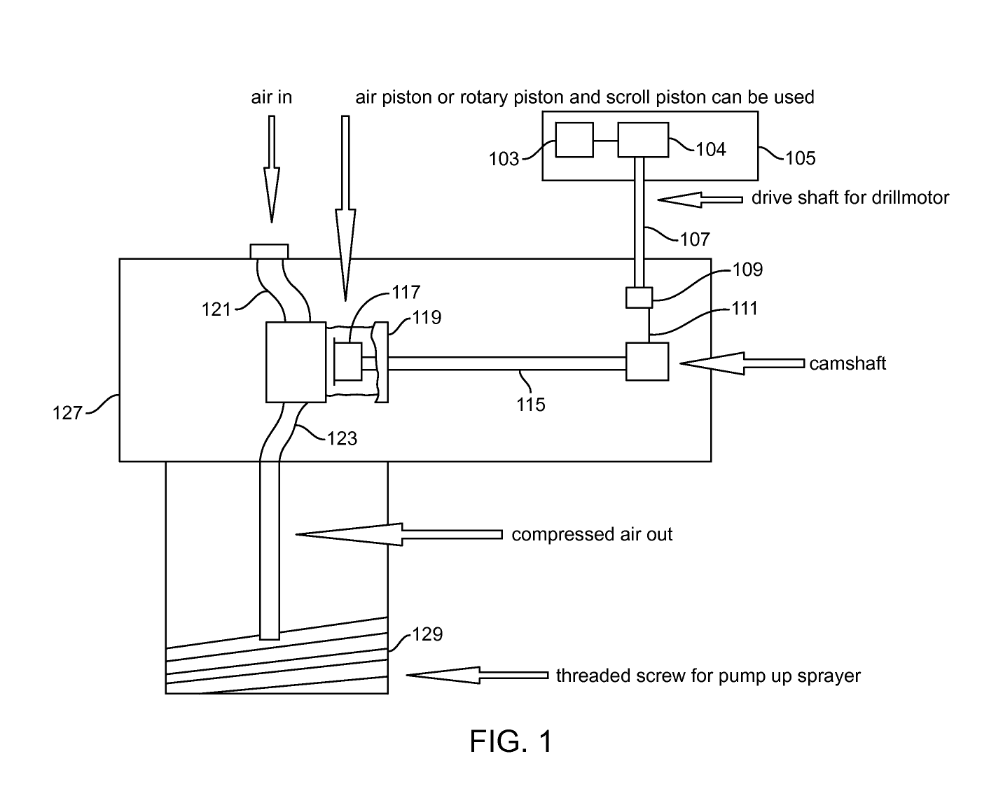

FIG. 1 illustrates a cleaning system 100 which may be used for cleaning coils of an air-conditioning system and includes a portable power supply 105 which may include a battery 103 and a motor 101 which may be powered by and connected to the battery 103. The portable power supply 105 may be connected to an electrical supply through a plug (not shown) and may be a portable electric drill. The motor 101 may be connected to a first connector shaft 107. The first connector shaft 107 which may rotate in response to the rotation of the motor 101 may be connected to a first connector device 109 which may be connected to a second connector shaft 111 which may be a drill bit and which may rotate in response to the rotation of the first connector shaft 107. The second connector shaft 111 may be connected to a cam 113 and may rotate the cam 113 which may be connected to a piston shaft 115 (a follower) which provides reciprocating (back and forth) linear motion. The piston shaft 115 may be connected to a piston 117 which may provide reciprocating linear motion in response to the linear motion of the piston shaft 115 within the piston chamber 119. Air enters the piston chamber 119 by an inlet passageway 121 and exits the piston chamber 119 by an outlet passageway 123. After the air has entered the piston chamber 119, a inlet valve and outlet valve which may be positioned in the inlet passageway 121 and the outlet passageway 123 respectively to close and to seal the piston chamber 119. The piston 117 pressurizes the air in the piston chamber 119, and the pressurized air is output through the outlet passageway 123 which may extend through the outlet connector 125 which may be connected to the housing 127. The outlet connector 125 may be a cylinder and may include a threaded portion 129 to attach to other devices such as a pump up sprayer (not shown).

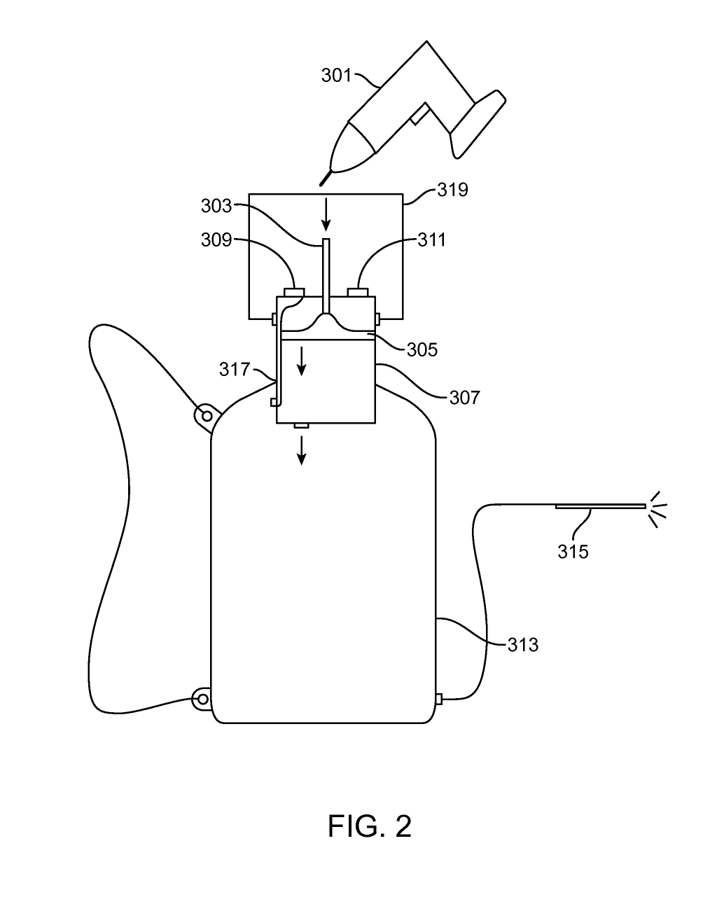

FIG. 2 illustrates another embodiment of the present invention and illustrates a cordless drill 301 which may be powered by a DC voltage such as 12 V or 15 V or higher. The cordless drill 301 may connect to a reciprocating rod 303 which may move in and out in response to the rotation of the drill of the cordless drill 301. The reciprocating rod 303 moves an in line rotary air pump or piston 305 to compress air within a chamber 307. The chamber 307 may include an adjustable regulator 309 which may adjust the pressure within the chamber 307. The chamber 307 may additionally include an air intake valve 311 to allow air to enter the chamber 307 after the compressed air has been released from the chamber 307. The piston 305 compresses the air/fluid in response to the reciprocating rod 303. The chamber 307 may be connected to a spraying container 313 which may store the compressed air until the user activates a spraying device 315 to release the compressed air. The sprayer container 313 may include an external strap 317 to allow the user to carry the spraying container 313. In addition, the chamber 307 may include a fold-down handle 319 to allow the user to carry the chamber 307.

Various compressors which may be used with the present invention are described below.

Hydraulic compressors are usually divided in four main groups: piston compressors, rotary vane compressors, rotary screw compressors and gear compressors. The piston-models are the most suitable for basic need for compressed air such as energizing small hand tools or air flushing of small quarry drills. Rotary vane-models include also a cooled lubrication system, oil separator, relief valve on the air intake and automatic rotation speed valve. Rotary vane-models are the most suitable for installation on different excavators, mining and other machines.

A reciprocating compressor or piston compressor is a positive-displacement compressor that uses pistons driven by a crankshaft to deliver gases at high pressure.

The intake gas enters the suction manifold, then flows into the compression cylinder where it gets compressed by a piston driven in a reciprocating motion via a crankshaft and is then discharged.

A rotary vane pump is a positive-displacement pump that consists of vanes mounted to a rotor that rotates inside of a cavity. In some cases these vanes can be variable length and/or tensioned to maintain contact with the walls as the pump rotates

A scroll compressor (also called spiral compressor, scroll pump and scroll vacuum pump) is a device for compressing air or refrigerant. It is used in air conditioning equipment, as an automobile supercharger (where it is known as a scroll-type supercharger) and as a vacuum pump.

A scroll compressor operating in reverse is known as a scroll expander, and can be used to generate mechanical work from the expansion of a fluid, compressed air or gas. Many residential central heat pump and air conditioning systems and a few automotive air conditioning systems employ a scroll compressor instead of the more traditional rotary, reciprocating, and wobble-plate compressors.

A rotary screw compressor is a type of gas compressor which uses a rotary type positive displacement mechanism. They are commonly used to replace piston compressors where large volumes of high pressure air are needed, either for large industrial applications or to operate high-power air tools such as jackhammers.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A cleaning system for providing a compressed fluid and to clean a coil of an air conditioner, comprising:
a portable power supply;
a motor connected to the portable power supply to rotate a shaft;
a cam connected to the shaft to drive a reciprocating linear motion camshaft;
a piston connected to the camshaft to provide pressurized fluid.

2) A cleaning system for providing a compressed fluid and to clean a coil of an air conditioner as in claim 1, wherein the portable power supply is a cordless drill.

3) A cleaning system for providing a compressed fluid and to clean a coil of an air conditioner as in claim 1, wherein the shaft is connected to a drill bit of a cordless drill.

4) A cleaning system for providing a compressed fluid and to clean a coil of an air conditioner as in claim 1, wherein the piston is a rotary piston.

5) A cleaning system for providing a compressed fluid and to clean a coil of an air conditioner as in claim 1, wherein the piston is a scroll piston.

6) A cleaning system for providing a compressed fluid and to clean a coil of an air conditioner as in claim 1, wherein the piston is an air piston.
